(19) United States
(12) Patent Application Publication
(10) Pub. No.: US 2020/0170755 A1
(43) Pub. Date: Jun. 4, 2020

(54) METHOD OF ASSISTING ORTHODONTICS AND ORTHODONTICS ASSISTING SYSTEM

(71) Applicant: 3M INNOVATIVE PROPERTIES COMPANY, St. Paul, MN (US)

(72) Inventors: Sonoko Kumamoto, Kyoto (JP); Kenichi Tajima, Tokyo (JP)

(21) Appl. No.: 16/616,121

(22) PCT Filed: May 10, 2018
(86) PCT No.: PCT/IB2018/053266

§ 371 Date: Nov. 22, 2019

(30) Foreign Application Priority Data
May 24, 2017 (JP) 2017-102565

(51) Int. Cl. A61C 7/00; A61C 7/28; A61C 9/00

(52) U.S. Cl. CPC A61C 7/002; A61C 9/0046; A61C 7/282

(57) ABSTRACT

An easier and more precise way of correcting an archwire in orthodontics. Resolution Means: A method of assisting orthodontics according to an embodiment including: a first acquisition step of acquiring target data showing a target dentition with a plurality of brackets installed; a second acquisition step of acquiring measurement data obtained by scanning an actual dentition of a patient with the plurality of brackets installed; a comparison step of obtaining a difference between the target data and the measurement data by comparing the target data and the measurement data; and a generation step of correcting a shape of an archwire attached to the plurality of brackets based on the difference, and generating wire data showing a corrected shape.

### TECHNICAL FIELD

An aspect of the present invention relates to a method of assisting orthodontics and an orthodontics assisting system.

### BACKGROUND ART

Methods and systems of assisting orthodontics are known in the related art. For example, Patent Document 1 describes a workstation for planning orthodontic treatment. The software executed by the workstation includes instructions providing graphical user interface for allowing the user to interactively create a set-up for treating the patient, and instructions for executing a series of processes to interactively evaluate the set-up. A set-up shows the target three-dimensional position of the teeth and craniofacial structure.

In another example, Patent Document 2 describes a method for producing a three-dimensional digital model of an orthodontic patient. The method includes the steps of: a) obtaining data of an orthodontic structure of the orthodontic patient; b) obtaining at least one scaling reference point of the orthodontic structure; c) scaling the data of the orthodontic structure based on the at least one scaling reference point to produce scaled data; d) obtaining at least two orientation reference points relating to the orthodontic structure; e) mapping the scaled data to a coordinate system based on the at least two orientation reference points to produce the three-dimensional digital model.

### PRIOR ART DOCUMENTS

### Patent Documents

Patent Document 1: US 2004/0197727

Patent Document 2: U.S. Pat. No. 6,512,994

### SUMMARY OF THE INVENTION

### Problem to be Solved by the Invention

Orthodontics typically has a relatively long treatment time. During the treatment time, to make the dentition of the patient the target shape, the doctor may correct the archwire fitted in a plurality of brackets as necessary. This correction is manually performed and takes a long time even if performed by a highly skilled doctor with much experience in orthodontics. Thus, there is a demand for an easier and more precise way of correcting an archwire in orthodontics.

### Means for Solving the Problem

A method of assisting orthodontics according to an aspect of the present invention is a computer-implemented method of assisting orthodontics, including: a first acquisition step of acquiring target data showing a target dentition with a plurality of brackets installed; a second acquisition step of acquiring measurement data obtained by scanning an actual dentition of a patient with the plurality of brackets installed; a comparison step of obtaining a difference between the target data and the measurement data by comparing the target data and the measurement data; and a generation step of correcting a shape of an archwire attached to the plurality of brackets based on the difference, and generating wire data showing a corrected shape.

An orthodontics assisting system according to an aspect of the present invention includes: a first acquiring unit configured to acquire target data showing a target dentition with a plurality of brackets installed; a second acquiring unit configured to acquire measurement data obtained by scanning an actual dentition of a patient with the plurality of brackets installed; a comparing unit configured to obtain a difference between the target data and the measurement data by comparing the target data and the measurement data; and a generating unit configured to correct a shape of an archwire attached to the plurality of brackets based on the difference, and generate wire data showing a corrected shape.

### Effect of the Invention

According to an aspect of the present invention, archwire correction in orthodontics can be performed in an easier and more precise way.

### BRIEF DESCRIPTION OF THE DRAWINGS

FIG. 1 is a view illustrating a concept of orthodontics.

FIG. 2 is a view illustrating an overall configuration of an orthodontics assisting system according to an embodiment.

FIG. 3 is a view illustrating a hardware configuration of a computer using an orthodontics assisting system according to an embodiment.

FIG. 4 is a view illustrating a functional configuration of an orthodontics assisting system according to an embodiment.

FIG. 5 is a view illustrating a configuration for scanning a dentition of a patient.

FIG. 6 is a view illustrating a process of generating an initial dentition shape and a target dentition shape.

FIG. 7 is a view illustrating an example of a generated archwire.

FIG. 8 is a view illustrating an example of generated brackets.

FIG. 9 is a flowchart illustrating an archwire correction process according to an embodiment.

FIG. 10 is a view illustrating a configuration of an orthodontics assisting program according to an embodiment.

### DESCRIPTION OF THE PREFERRED EMBODIMENTS

Embodiments of the present invention are described in detail below with reference to the attached drawings. Note that in the descriptions of the drawings, the same reference symbols have been assigned to elements that are the same or equivalent, and that redundant descriptions thereof have been omitted.

An orthodontics assisting system 1 according to an embodiment is a user-interactive computer system for assisting orthodontics of a patient. “Orthodontics” is a treatment to correct malocclusion involving manipulating the position of teeth of a patient. “User” is a person giving orthodontic treatment and includes, for example, a dentist and a dental technician. “Patient” is a person receiving orthodontic treatment.

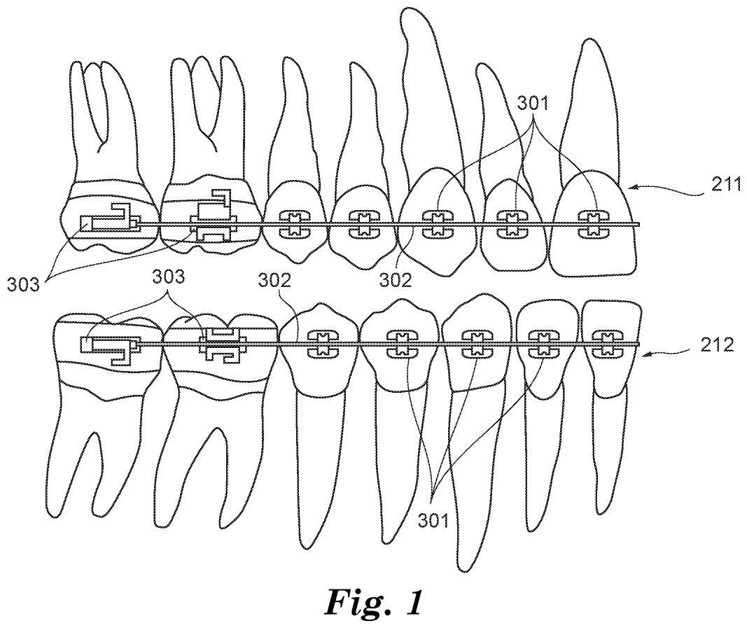

FIG. 1 illustrates a concept of orthodontics. In typical orthodontic treatment, a plurality of brackets (small slotted appliances) 301 configured to bond to anterior, cuspid, and bicuspid teeth of the patient and an archwire 302 that fits in the slots of the brackets 301 are used. The brackets 301 may be customized to each patient or may be designed to be suitable for a variety of patients. The archwire 302 serves as a track to guide the teeth to desired orientations. Typically, end portions of the archwire 302 are fixed to an appliance known as a buccal tube 303 fixed to a molar tooth of the patient. FIG. 1 illustrates an example in which orthodontic appliances are attached to upper teeth (dentition supported by the upper jaw) 211 and lower teeth (dentition supported by the lower jaw) 212 of the patient. An orthodontic appliance refers to a set including the brackets 301, the archwire 302, and the buccal tubes 303. In the embodiments below, as an example, the brackets and the archwire of the orthodontic appliance will be described.

An orthodontics technique widely used today is the edgewise technique. In this technique, the shape of the brackets, including the orientation of the slots, and the bonding position of the brackets are selected such that the slots are positioned on a level reference plane when the treatment is complete (when the desired dentition is achieved). Furthermore, an elastic archwire with a shape that curves in the level reference plane is used. In this technique, the slots are brought into alignment on the reference plane utilizing the action of the archwire trying to level out, without any force being applied, to achieve the desired dentition.

The brackets may be attached to the lingual surface of the teeth of the labial/buccal surface of the teeth. Lingual orthodontics of attaching the brackets on the lingual surface of the teeth is advantageous in that the orthodontic appliance can be hidden by the teeth or made largely unnoticeable by other people. One such lingual orthodontic product is the Incognito™ Appliance System available from 3M Company. The embodiments below will be described using an example in which the surfaces of the brackets that bond to the teeth are customized to have a shape that conforms to at least a portion of the shape of the lingual surfaces of the teeth of the patient.

The edgewise technique takes into consideration parameters pertaining to the movement direction of the teeth including the in-out relationship, torque, angulation, and rotation. In-out relationship is a parameter for how much the tooth moves to the lingual side or the labial/buccal side. Torque is a parameter for how much the tooth tilts to the lingual side or the labial/buccal side. By taking torque into consideration, a desired tooth angle with respect to the vertical plane can be achieved. Angulation is a parameter for how much the tooth tilts to the mesial side or the distal side. By taking angulation into consideration, a desired tooth angle as viewed in the mesial-distal direction can be achieved. Rotation is a parameter for how much the tooth rotates about an axis orthogonal to the occlusal surface. In one form of the edgewise technique known as the standard edgewise technique, these parameters are incorporated in the archwire. In a technique different from the edgewise technique known as the straight wire technique, the parameters are incorporated in the brackets.

Next, some orthodontic terminology will be explained. “Mesial side” means the direction toward the median (between the first tooth on the right and the first tooth on the left, i.e., the midline of the dental arch). “Distal side” means the direction away from the median. “Labial/buccal side” means the direction toward the cheek or lips. “Lingual side” means the direction toward the tongue (or palate). “Occlusal side” means the direction out from the tip portion of the tooth. “Gingival side” means the direction toward the gingiva or gum.

To achieve the desired dentition, the shape and bonding position of the brackets and the curve of the archwire need to be accurate. This requires a great deal of experience in treatment planning and actual treatment. In recent years, at least a part of the design and manufacture of orthodontic appliances has come to be performed by computers. Such computer systems have decreased the time of planning and treatment compared to conventional means and resulted in greater accuracy. For example, a computer can acquire data of the dentitions of patients and visualize the dentition of the patient using the acquired data to diagnose and form an orthodontic plan in any stage of the treatment. Such computer-based techniques are, for example, described in JP 2005-516727 A, JP 2008-515541 A, JP 2010-533008 A, and JP 2014-512891 A. The entire contents of these four documents are included in the present specification for reference but do not limit the disclosure of the present specification.

Orthodontics requires a set amount of time, and during the treatment period, the curve of the archwire is corrected (adjusted) as necessary. For example, in the treatment process, positional or rotational deviation in the mesial-distal direction (angulation deviation) and/or deviation in the lingual-labial/buccal direction (torque deviation) may occur. In the related art, when the movement of a tooth deviates from the original plan, the user corrects at least a portion of the curve of the archwire, and fits the corrected archwire in the brackets to compensate for the deviation. This correction operation requires much experience and great skill. Also, it is a manual operation that takes a long time. As the deviation amount and the wire correction amount cannot be quantitatively obtained, a process becomes necessary in which the corrected wire is installed, then during checkups, the progress of movement of the tooth is observed and the wire is corrected again. The orthodontics assisting system 1 according to the present embodiment assists correction operation by a computer generating wire data used to appropriately compensate for deviation from the planned movement of the teeth.

### Embodiments

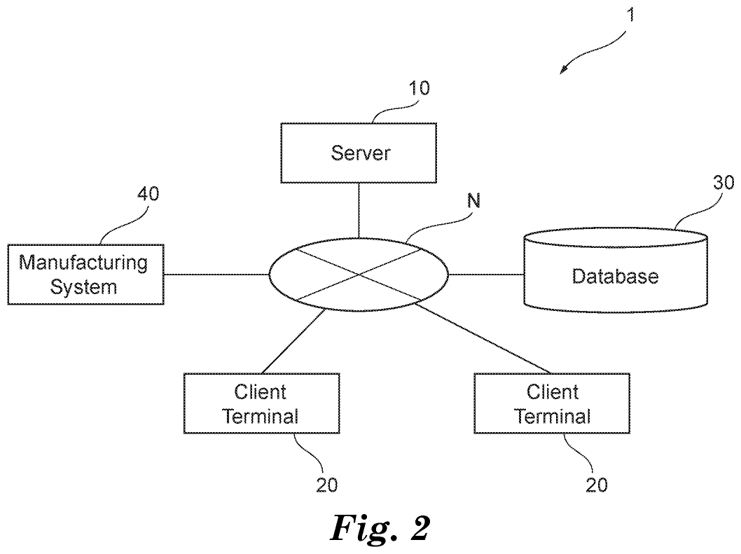

FIG. 2 illustrates an example of an overall configuration of the orthodontics assisting system 1. In the present embodiment, the orthodontics assisting system 1 includes a server 10, at least one client terminal 20, and a database 30. The server 10 and the client terminal 20 can send and receive data to/from one another via a communication network N such as a wired or wireless internet or intranet. The server 10 can access the database 30 via the communication network N. The specific configuration of the communication network N, i.e., how the devices are specifically connected, is not limited in any way. The orthodontics assisting system 1 works in conjunction with a manufacturing system 40, which is a computer system configured to manufacture actual orthodontic appliances. The manufacturing system 40 may be a system independent of the orthodontics assisting system 1 or may be incorporated in the orthodontics assisting system 1.

The server 10 is a computer configured to provide a service to the client terminal 20. The server 10 performs a process in response to a request from the client terminal 20, and transmits to the client terminal 20 predetermined data as the response to the request. The server 10 may be composed of a single computer or the computing resources for running the software may be spread across a plurality of different computers. When a plurality of computers are used, the computers are connected via a communication network such as the Internet or intranet, logically making one server 10. For example, the server 10 may be a cloud server or a physical server.

The client terminal 20 is a computer configured to be used by a user. Examples of the client terminal 20 include a stationary or portable personal computer and a portable terminal such as a tablet terminal or smartphone. The client terminal 20 is not limited to a specific type. The client terminal 20 is configured to request predetermined data from the server 10 in response to a user operation, receive data sent from the server 10 in response to this request, and display and/or store this data. Such a function may be performed in a web browser or provided via a dedicated application program.

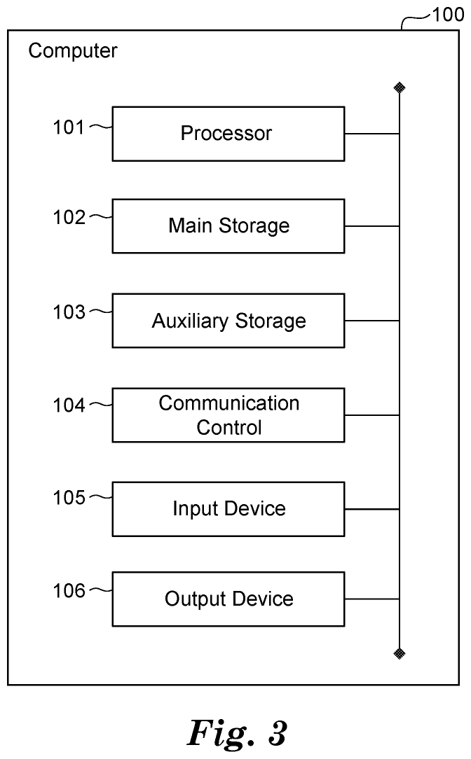

FIG. 3 illustrates a typical hardware configuration of a computer 100 that functions as the server 10 or the client terminal 20. The computer 100 includes a processor (for example, a CPU) 101 configured to execute an operating system and/or an application program, a main storage 102 composed of ROM or RAM, an auxiliary storage 103 composed of a hard disk or flash memory, a communication control 104 composed of a network card or a wireless communication module, an input device 105 such as a keyboard, mouse, touch panel, and the like, and an output device 106 such as a monitor, touch panel, and the like. Naturally, the components of the computer 100 vary depending on the type of the computer 100. For example, a stationary or portable personal computer typically includes a keyboard and mouse as the input device 105 and a monitor as the output device 106. A tablet terminal and a smartphone typically include a touch panel that functions as both the input device 105 and the output device 106.

The functional elements of the server 10 and the functional elements of the client terminal 20 are realized by a predetermined software (for example, a server program P1 or a client program P2 described below) being read into the processor 101 or the main storage 102, and this software being executed. The processor 101 is configured to activate the communication control 104, the input device 105, and the output device 106 in accordance with this software and read and write data in the main storage 102 or the auxiliary storage 103. The data or database required for the process is stored in the main storage 102 or the auxiliary storage 103.

The database 30 is a functional element or a device configured to store a data set allowing for response to a data operation from a processor or an external computer. The data operation associated with the database 30 includes, for example, extracting, adding, deleting, and overwriting. The database 30 is typically built via a database management system. The database management system may be a relational (RDBMS), hierarchical (HDBMS), multidimensional (MDBMS), object-oriented (ODBMS or OODBMS), or object-relational (ORDBMS) database management system.

The database 30 stores treatment planning data relating to orthodontic treatment of the patient. In the present embodiment, the treatment planning data includes data items of patient ID, initial dentition shape, target dentition shape, wire data, and bracket data, and the data items are sorted associated with one another. Patient ID is an identifier for uniquely identifying patients. Initial dentition shape is data showing the three-dimensional shape of the dentition of the patient before treatment. Target dentition shape is data showing the three-dimensional shape of the dentition (target dentition) of the patient after treatment. Wire data is data showing the structure and shape of the archwire used in the orthodontic treatment. Bracket data is data showing the structure, attachment position, and attachment orientation of the brackets used in the orthodontic treatment. Wire data is data of the archwire for the lower dentition and/or of the archwire for the upper dentition. Bracket data is data of the bracket subset for the lower dentition and/or of the bracket subset for the upper dentition. When the brackets are customized to the patient, the brackets are used until the completion of treatment without being replaced during the treatment. Thus, there is only one bracket set appliance structure, and the treatment planning data for one patient includes one type of bracket data. In contrast, when the brackets are replaced in accordance with the stage of treatment, the bracket set appliance structure changes depending on the stage. Thus, there are a plurality of bracket set structures, and the treatment planning data for one patient includes a plurality of types of bracket data.

The initial dentition shape, target dentition shape, wire data, and bracket data can be drawn on the computer with a predetermined graphics software installed. For example, a doctor or patient can easily understand information relating to the dentition and appliances via a visual display generated by computer graphics.

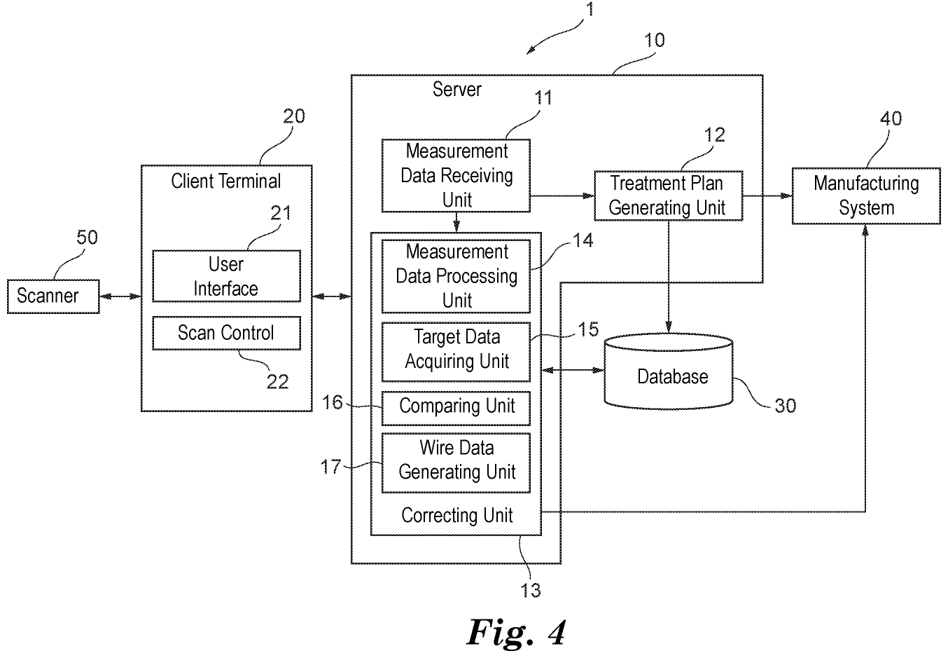

FIG. 4 illustrates a functional configuration of the orthodontics assisting system 1. The functions of the server 10 and the client terminal 20 will be described in detail with reference to FIG. 4.

The function and configuration of the client terminal 20 will first be described. The client terminal 20 is configured to acquire data showing the current dentition (actual dentition) of the patient, graphically display the dentition shape, and perform a predetermined process depending on the instruction input by the user. The client terminal 20 includes a user interface 21 and a scan control 22 as functional components.

The user interface 21 is a functional element configured to display data and instructions input by the user and typically is displayed on a screen of a display device (not illustrated) in a visually recognizable manner. For example, the user interface 21 includes a region where the dentition and/or the orthodontic appliance is visually displayed and a graphical user interface (GUI) configured to receive operations associated with the dentition or the orthodontic appliance and a predetermined instruction for the server 10. Examples of the GUI include a cursor, icon, list box, text box, and the like. Naturally, the specific configuration of the user interface 21 is not limited to this configuration.

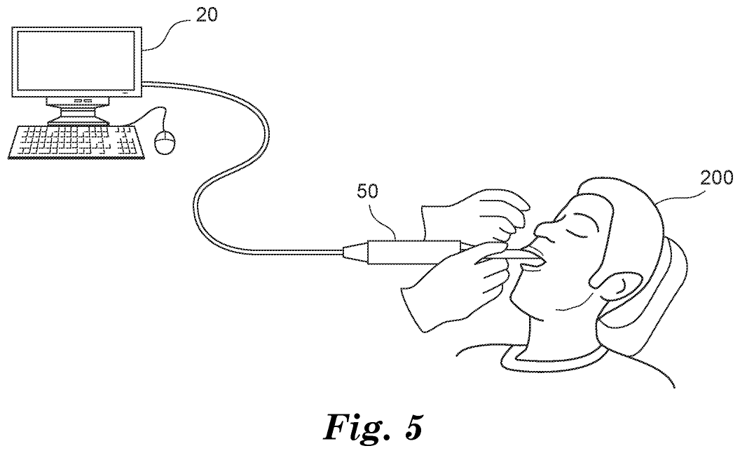

The scan control 22 is configured to acquire point cloud data illustrating the three-dimensional shape of the actual dentition of the patient. FIG. 5 illustrates an example of the configuration for acquiring the point cloud data at the client terminal 20. In this example, the client terminal 20 is configured to communicatively connect to a scanner 50 that is configured to acquire an image of a dentition by scanning the dentition of a patient 200. The client terminal 20 and the scanner 50 have a wired or wireless connection. An example of the scanner 50 includes the intra-oral scanner known as “3M™ True Definition Scanner” available from 3M Company.

However, the scanner 50 is not limited thereto. For the scanner 50, any scanning method may be used that can acquire a three-dimensional intraoral surface shape. Any suitable scanning technique may be used for scanning, examples including X-ray radiography, laser scanning, light scanning, active wavefront sampling, computed tomography (CT scanning), ultrasound imaging, and magnetic resonance imaging (MRI). The scanner 50 is configured to image or scan the dentition and generate point cloud data from the image. This point cloud data may then be sent to the client terminal 20. Alternatively, the scanner 50 may send the image to the client terminal 20, and the scan control 22 may generate the point cloud data from the image. Point cloud data is data showing a point cloud in three-dimensional space. By “surfacing” the data, a virtual dentition model showing the surfaces of the teeth, gums, other oral structures, and orthodontic appliances can be generated.

In the present embodiment, the dentition of the patient is scanned at different times at least twice. The initial scan is performed to obtain the actual dentition of the patient before treatment. At this time, the scan control 22 acquires point cloud data showing the dentition without the orthodontic appliance attached. The second and subsequent scans are performed to obtain the actual dentition of the patient during treatment. At this time, the scan control 22 acquires point cloud data showing the dentition with at least the brackets attached. Scanning the dentition with the brackets installed allows the position and orientation of the brackets in the mouth to be acquired. Additionally, the brackets do not need to be removed for scanning. For example, when the brackets are customized to the shape of the teeth of the patient, even in cases where the brackets are not removed during treatment or when the frequency at which the brackets are replaced is less relative to the frequency at which the wires are replaced, the surface shape of the teeth and the positions of the brackets can be acquired. Additionally, the relative positional relationship between the bracket and the tooth can be accurately obtained. Thus, the wire can be accurately corrected.

The point cloud data of the dentition surface can be acquired by scanning either a positive or negative impression of the teeth of the patient. The dentition surface can be acquired using a contact probe on a model of the teeth of the patient. The point cloud data of the dentition surface may be generated by casting an impression of the dentition of the patient using impression material and scanning this impression (cast). Examples of methods of scanning an impression (cast) include X-ray fluoroscopy, laser scanning, computed tomography, magnetic resonance imaging, and ultrasound imaging.

The point cloud data can be used for a variety of purposes. For example, the user interface 21 displays a three-dimensional image on the display device (not illustrated) by rendering the point cloud data, which allows the user or the patient to view the current dentition of the patient. The scan control 22 is configured to generate measurement data including point cloud data, patient ID, and scan type and send this measurement data to the server 10. Scan type is a value that represents the stage when the dentition is scanned. In the present embodiment, these are two stages, “before treatment (initial scan)” and “during treatment (second and subsequent scans)”. In the present embodiment, measurement data with the scan type indicating “during treatment” also serves to request the server 10 to correct an archwire.

Next, the server 10 will be described. The server 10 includes a measurement data receiving unit 11, a treatment plan generating unit 12, and a correcting unit 13 as functional components. The correcting unit 13 includes a measurement data processing unit 14 (second acquiring unit), a target data acquiring unit 15 (first acquiring unit), a comparing unit 16, and a wire data generating unit 17.

The measurement data receiving unit 11 is configured to receive measurement data from the client terminal 20. The measurement data receiving unit 11 is configured to send received measurement data to the treatment plan generating unit 12 when this measurement data has the scan type indicating “before treatment”, and send received measurement data to the correcting unit 13 when this measurement data has the scan type indicating “during treatment”.

The treatment plan generating unit 12 is configured to generate treatment planning data. The treatment plan generating unit 12 is configured to generate an initial dentition shape and a target dentition shape by surfacing the point cloud data included in the measurement data. “Initial dentition shape” is data showing a three-dimensional shape of the dentition of the patient before treatment. “Target dentition shape” is data showing a three-dimensional shape of the dentition of the patient after treatment.

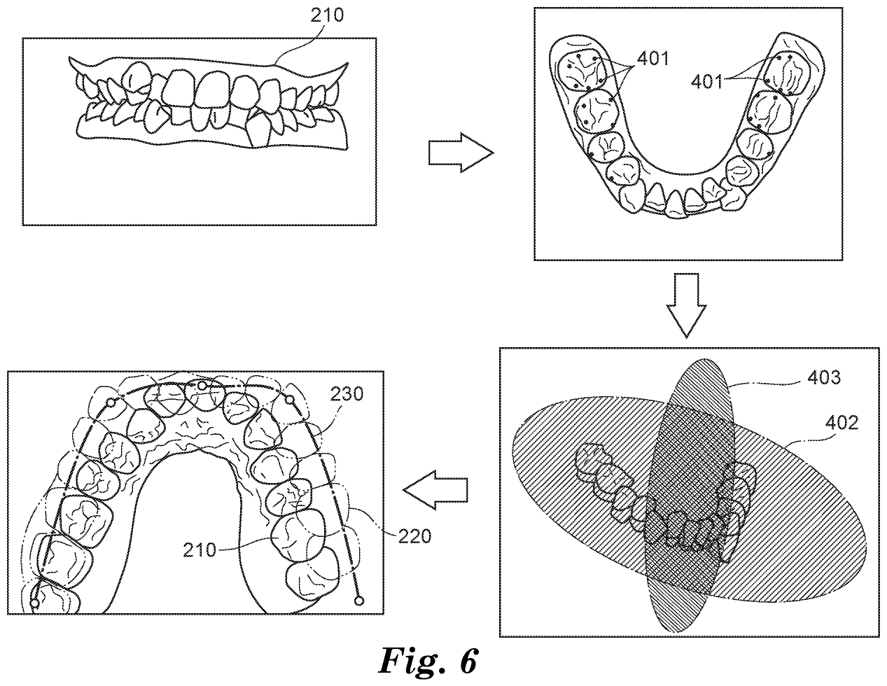

The method of generating the target dentition shape and the initial dentition shape is not limited, and for example, the treatment plan generating unit 12 may generate the dentition shapes using a method known as segmentation on the dentition. Though, segmentation of a dentition is a known technique, this method will be summarized below with reference to FIG. 6. FIG. 6 illustrates a procedure of generating two types of dentition shapes. The treatment plan generating unit 12 automatically or in accordance with user input (input via the client terminal 20) executes the following steps to generate a dentition shape.

First, the treatment plan generating unit 12 acquires a three-dimensional shape of the dentition surface by surfacing the point cloud data. A dentition surface 210 illustrated in FIG. 6 is an example of a three-dimensional shape able to be obtained by this process. Next, the treatment plan generating unit 12 segments (segmentation) the teeth as objects distinct from the gums and other oral structures. Then, the treatment plan generating unit 12 virtually segments the dentition surface into individual elements so that each tooth can be moved as an object independent of other objects. The treatment plan generating unit 12 segments each tooth by defining the boundary of each tooth and recognizes each tooth to obtain the initial dentition shape. Segmenting the surface of the dentition allows each tooth to be manipulated.

Next, the treatment plan generating unit 12 defines a coordinate system for the surface of each tooth. As illustrated in FIG. 6, the treatment plan generating unit 12 sets a plurality of landmarks 401 on the occlusal surfaces of the teeth. Then, the treatment plan generating unit 12 defines a coordinate system including a mesial-distal axis, labial/buccal-lingual axis, and occlusal-gingival axis based on the landmarks. By defining the coordinate system for each tooth, changes in rotation, translation, and the like with respect to the initial dentition shape are made possible. Next, the treatment plan generating unit 12 applies a virtual root stub to the surfaces of the teeth. Root stub is a digital representation to help the user visualize the orientation of each tooth with respect to the neighboring tooth. Then, as illustrated in FIG. 6, the treatment plan generating unit 12 defines an occlusal surface 402 and a midsagittal plane 403. “Occlusal surface” is an imaginary plane that passes through the occlusal portion of the teeth and typically includes one contact point on a left molar, one contact point on a right molar, and one contact point on a central or lateral tooth. “Midsagittal plane” is an imaginary plane passing through the median and dividing the dentition into left and right halves.

Next, the treatment plan generating unit 12 adjusts the position and the orientation of the surface of each tooth to dispose the tooth surfaces in the archform of the jaw (the upper jaw and/or lower jaw) which is the target of the orthodontic treatment. The treatment plan generating unit 12 disposes the tooth surfaces according to an algorithm based on known guidelines, formulations, and regulations for orthodontics. The treatment plan generating unit 12 may adjust each tooth in terms of torque, angulation, rotation, position in the mesial-distal direction, position in the occlusal-gingival direction, and position in the labial/buccal-lingual direction.

The treatment plan generating unit 12 performs adjustment to ensure neighboring teeth do not collide and to achieve occlusion (proper interaction between the dentitions of the upper and lower jaw). Then, the treatment plan generating unit 12 sets a desired occlusion by adjusting the dentition surfaces. The treatment plan generating unit 12 performs this adjustment taking into consideration, for example, the archform, relationship in dentition length between the upper jaw and lower jaw, coordinate system of each tooth (i.e., the position and orientation of each tooth), and the size and shape of the teeth. Additionally, the treatment plan generating unit 12 simulates the occlusion of the dentition (movement of the jaw joints and jaw) and more accurately adjusts the collision between the dentitions of the upper jaw and lower jaw to obtain the target dentition shape. FIG. 6 illustrates an example in which an archform 230 was used to achieve a target dentition shape 220 from an initial dentition shape 210.

Next, the treatment plan generating unit 12 sets the dimensions (length and diameter) and shape of the archwire based on the target dentition shape. The shape of the set archwire has a U-shape in a single plane. The treatment plan generating unit 12 divides the archwire into a plurality of segments that correspond to each tooth, and determines the dimensions and shape of each segment. Each segment can be represented in a desired geometrical relationship. For example, the segments may be represented in a linear geometrical relationship including lines, polylines, and the like or may be represented in a non-linear geometrical relationship including circular curves, parabolic curves, elliptical curves, catenary curves, and the like. Alternatively, the segments may be represented in a higher order geometrical relationship including parametric cubic curve segments, cubic splines, and the like. The treatment plan generating unit 12 generates the wire data of the whole archwire by connecting the drawn out segments. The treatment plan generating unit 12 may perform smoothing on the connection points where segments are connected.

Next, the treatment plan generating unit 12 determines the shape and attachment position of the brackets based on the initial dentition shape, target dentition shape, and archwire shape.

As described above, the shape and attachment position of the brackets are determined such that the archwire of the target dentition shape curves in a single plane. The treatment plan generating unit 12 determines the shape and dimensions of the bracket pad based on the corresponding tooth surface and determines the shape and dimensions of the bracket body including the slot based on at least one of: the initial dentition shape, target dentition shape, and archwire shape. The treatment plan generating unit 12 may retrieve a bracket body suitable for each tooth from a library of bracket bodies (a database in which preset designs of bracket bodies are stored). The treatment plan generating unit 12 derives for each tooth the bracket to be bonded thereto by connecting the bracket pad to the bracket body. As a result, bracket data is obtained.

The parameters taken into consideration for the edgewise technique including the in-out relationship, torque, angulation, and rotation are incorporated in the wire data or bracket data.

The treatment plan generating unit 12 generates treatment planning data by associating the patient ID with the initial dentition shape, target dentition shape, wire data, and bracket data obtained by the series of processes described above and stores this treatment planning data in the database 30.

Additionally, the treatment plan generating unit 12 transmits the treatment planning data to the manufacturing system 40. The manufacturing system 40 manufactures an indirect bonding tray with embedded brackets and an archwire from the treatment planning data. Examples of a device including the manufacturing system 40 include a milling system, a three-dimensional lithography system, a three-dimensional printer, and a six-axis robot. However, no limitation is intended. The manufactured orthodontic appliance is installed in the patient.

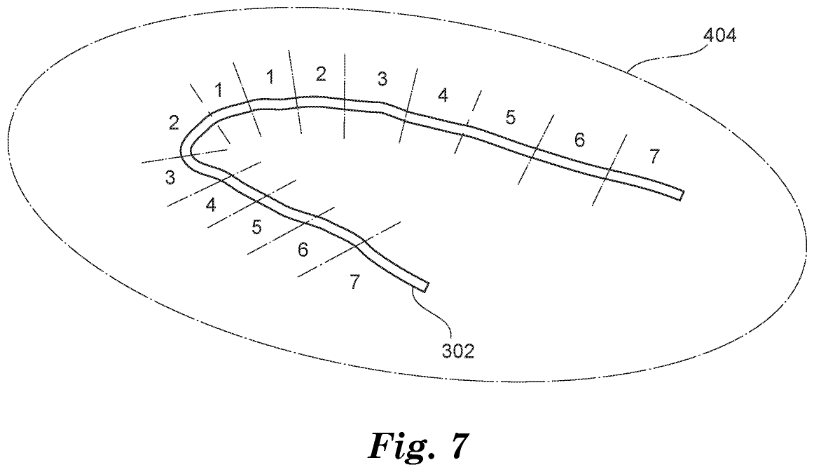

FIG. 7 illustrates an example of visualized wire data or an example of the manufactured archwire 302. The archwire 302 is curved in a plane 404. This shape represents the archwire 302 without any external force being applied and also represents the target dentition of the dentition of the patient (i.e., state when treatment is completed). When the archwire 302 is applied to dentition with malocclusion, the archwire 302 deforms due to the malocclusion.

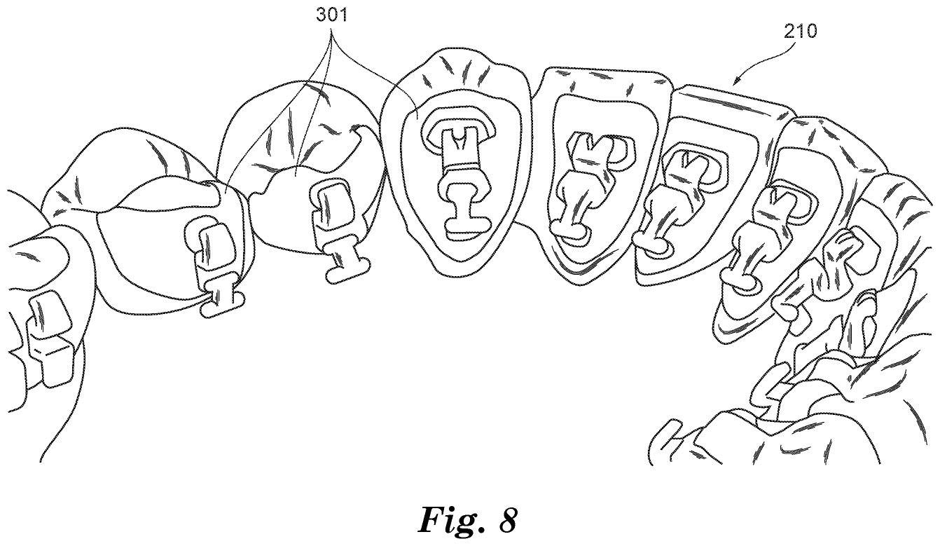

FIG. 8 illustrates an example of visualized brackets or an example of the manufactured brackets 301. Note that to facilitate understanding, a dentition 210 and the brackets 301 are both illustrated in FIG. 8. The archwire 302 is fit in the slots of the brackets 301.

The correcting unit 13 is a functional element configured to correct the archwire and performs a distinctive function of the server 10. The functional elements composing the correcting unit 13 will be described in detail below.

The measurement data processing unit 14 acquires measurement data obtained by scanning the actual dentition of the patient with the brackets installed. The measurement data processing unit 14, upon measurement data (point cloud data) being input, processes the point cloud data in a similar manner to that of the treatment plan generating unit 12 to obtain a current dentition shape of the patient with the brackets installed. In other words, the measurement data processing unit 14 acquires a three-dimensional shape of the dentition surface with the brackets installed by surfacing the point cloud data. Next, the measurement data processing unit 14 virtually segments the three-dimensional shape of the dentition surface with the brackets installed into the dentition, gums, other oral structures, and brackets. Then, the measurement data processing unit 14 virtually segments the dentition surface into individual elements. Next, the measurement data processing unit 14 obtains the position and orientation of the segmented brackets. To increase the accuracy of this computation, the measurement data processing unit 14 may obtain the actual position and orientation of the brackets with the minimum matching error with respect to the shape of the brackets represented by the target data (described below) while referencing the three-dimensional shape of the brackets represented by the target data. The measurement data processing unit 14 may obtain the position and orientation of the slots of the brackets and not that of the brackets. The measurement data processing unit 14 outputs the processed measurement data to the comparing unit 16.

The target data acquiring unit 15 reads the target dentition shape from the database 30. The target data acquiring unit 15 reads from the database 30 the treatment planning data corresponding to the patient ID included in the measurement data received from the client terminal 20. Next, the target data acquiring unit 15 uses the target dentition shape and bracket data included in this treatment planning data to generate the target data showing the target of the dentition of the patient with the brackets installed (target dentition). The target data acquiring unit 15 outputs this target data to the comparing unit 16.

The comparing unit 16 obtains the difference between the target data and the comparison data by comparing the two. The comparing unit 16 compares the position and orientation of the brackets represented by the target data to the position and orientation of the brackets represented by the comparison data to obtain the difference between the target position and orientation of the brackets and the current position and orientation of the brackets. The comparing unit 16 outputs the difference in the brackets to the wire data generating unit 17.

The wire data generating unit 17 corrects the shape of the archwire based on the difference between the target data and the comparison data and generates wire data showing the corrected shape. The wire data generating unit 17 may normally generate wire data without referencing a value of the difference or may generate wire data only when the difference is a value greater than a predetermined threshold value. The wire data generating unit 17 may only generate wire data when it has been determined that the value of the difference of at least a predetermined number of brackets (for example, at least one, at least two, or at least three) is a value greater than a predetermined threshold value.

The wire data generating unit 17 reads from the database 30 the wire data corresponding to the patient ID for wire data correction. The wire data generating unit 17 corrects the shape of the archwire represented by the wire data based on the difference between the target data and the comparison data and generates new wire data showing the corrected archwire. As described above, the archwire represented by the wire data is divided into segments corresponding to each of the brackets. The wire data generating unit 17 corrects the shape of the archwire in each segment.

The identifier for segments is set to i, and the positional information relating to the i-th segment of the archwire is defined as follows.

X (position, i): vector information representing the new position of the i-th segment. The definition of the position is not limited thereto, and for example, the position of the center of gravity or the average position of the segment may be used, or another predetermined position may be used.

X (ini_position, i): vector information representing the pre-correction position of the i-th segment.

Δb (position, i): positional difference between target data and measurement data.

Here, the new position of the i-th segment is obtained via Formula (1) below.

Equation 1

X(position,i)=X (int_position, i)+αᵢ(Δb(position,i)) (1)

αᵢ represents the direction opposite the direction the difference is found in and is a function that returns a larger absolute value the larger the difference.

Accordingly, for example, when a tooth corresponding to a certain segment has not moved in the desired direction as much as planned, the segment is corrected to aggressively move the tooth in the desired direction. This is what correcting the archwire to curve the segment further in a desired direction means. When a tooth corresponding to a certain segment has moved in the desired direction more than as planned, the segment is corrected to suppress movement of the tooth. This is what correcting the archwire to decrease the degree of curve in the segment or curve the segment in the direction opposite a desired direction means.

Torque, angulation, and rotation can be corrected in a manner similar to position as described below.

The torque information relating to the i-th segment is defined as follows.

Θ (torque, i): new torque of the i-th segment.

Θ (ini_torque, i): pre-correction torque of the i-th segment.

Δb (torque, i): torque difference between target data and measurement data.

Here, the new torque of the i-th segment is obtained via Formula (2) below.

Equation 2

Θ (torque,i)=Θ(ini_torque,i)+βᵢ(Δb(torque,i)) (2)

βᵢ represents the direction opposite the direction the difference is found in and is a function that returns a larger absolute value the larger the difference.

Accordingly, for example, when a tooth corresponding to a certain segment has not tilted in the desired direction as much as planned for the labial/buccal-lingual direction, the segment is corrected to aggressively tilt the tooth in the desired direction. This is what correcting the archwire to twist the segment further in a desired direction means. When a tooth corresponding to a certain segment has tilted in the desired direction more than as planned for the labial/buccal-lingual direction, the segment is corrected to suppress tilting of the tooth. This is what correcting the archwire to decrease the degree of twist in the segment or twist the segment in the direction opposite a desired direction means.

The angulation information relating to the i-th segment is defined as follows.

Θ (angulation, i): new angulation of the i-th segment.

Θ (ini_angulation, i): pre-correction angulation of the i-th segment.

Δb (angulation, i): angulation difference between target data and measurement data.

Here, the new angulation of the i-th segment is obtained via Formula (3) below.

Equation 3

Θ (angulation,i)=Θ(ini_angulation,i)+γᵢ(Δb(angulation,i)) (3)

γᵢ represents the direction opposite the direction the difference is found in and is a function that returns a larger absolute value the larger the difference.

Accordingly, for example, when a tooth corresponding to a certain segment has not tilted in the desired direction as much as planned for the mesial-distal direction, the segment is corrected to aggressively tilt the tooth in the desired direction. This is what correcting the archwire to twist or curve the segment further in a desired direction means. When a tooth corresponding to a certain segment has tilted in the desired direction more than as planned for the mesial-distal direction, the segment is corrected to suppress tilting of the tooth. This is what correcting the archwire to decrease the degree of twist or curve in the segment or twist or curve the segment in the direction opposite a desired direction means.

The rotation information relating to the i-th segment is defined as follows.

Θ (rotation, i): new rotation of the i-th segment.

Θ (ini_rotation, i): pre-correction rotation of the i-th segment.

Δb (rotation, i): rotation difference between target data and measurement data.

Here, the new rotation of the i-th segment is obtained via Formula (4) below.

Equation 4

θ(rotation,i)=Θ(ini_rotation,i)+ηᵢ(Δb(rotation,i)) (4)

ηᵢ represents the direction opposite the direction the difference is found in and is a function that returns a larger absolute value the larger the difference.

Accordingly, for example, when a tooth corresponding to a certain segment has not rotated in the desired direction as much as planned about the axis orthogonal to the occlusal surface, the segment is corrected to aggressively rotate the tooth in the desired direction. This is what correcting the archwire to twist or curve the segment further in a desired direction means. When a tooth corresponding to a certain segment has rotated more than as planned about the axis orthogonal to the occlusal surface, the segment is corrected to suppress rotation of the tooth. This is what correcting the archwire to decrease the degree of twist or curve in the segment or twist or curve the segment in the direction opposite a desired direction means.

Correction based on Formulae (1) to (4) means deforming the archwire in the direction opposed to the difference. In other words, the wire data generating unit 17 determines the direction opposed to the difference for each segment of the archwire based on at least one of: its position, torque, angulation, and rotation, and deforms the archwire in that direction.

The wire data generating unit 17 adds the generated wire data to the treatment planning data of the corresponding patient ID and stores it in the database 30.

Additionally, the wire data generating unit 17 transmits the wire data to the manufacturing system 40. The manufacturing system 40 can manufacture a corrected archwire according to the wire data. The manufacturing system 40 may newly create a corrected version of the wire data or may obtain one by changing the existing wire data. The user attaches the corrected archwire to the patient. This readjustment raises the chances of the orthodontic treatment of the patient finishing early.

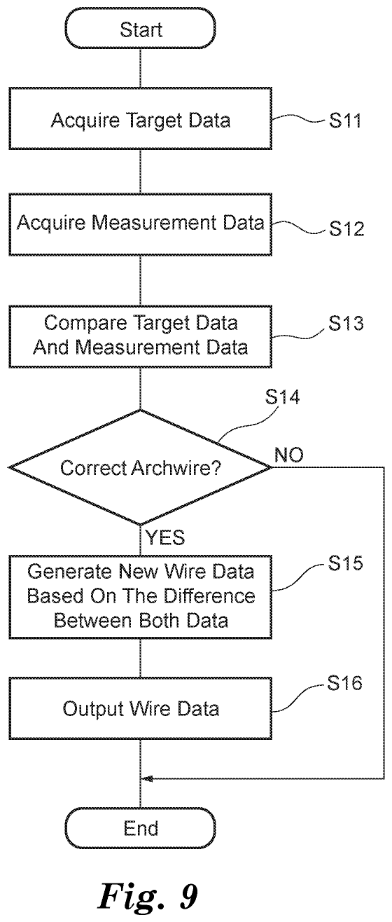

FIG. 9 is a flowchart illustrating an example of an archwire correction process. The operations of the orthodontics assisting system 1 and a method of assisting orthodontics according to the present embodiment will be described with reference to FIG. 9. In particular, archwire correction, which is a characteristic of the orthodontics assisting system 1, will be described.

First, the target data acquiring unit 15 acquires target data in response to a request from the client terminal 20 (step S11, first acquisition step), then the target data acquiring unit 15 reads from the database 30 the target dentition shape and bracket data corresponding to the patient ID indicated in the request and generates target data using this data. Target data shows the target of the dentition of the patient with the brackets installed on the teeth. Additionally, the measurement data receiving unit 11 receives point cloud data from the client terminal 20, and the measurement data processing unit 14 processes the point cloud data and acquires measurement data (step S12, second acquisition step). Measurement data shows the actual dentition of the patient with the brackets installed. Next, the comparing unit 16 obtains the difference between the target data and the measurement data by comparing the two (step S13, comparison step).

Then, the wire data generating unit 17 determines whether archwire correction is necessary (step S14). For example, the wire data generating unit 17 may determine that correction is necessary in the case where the difference is greater than a predetermined threshold value. In the case where archwire correction is determined to be performed (YES in step S14), the wire data generating unit 17 generates new wire data showing the correct shape of the archwire based on the difference obtained in step S13 (step S15, correction step). Next, the wire data generating unit 17 outputs the wire data obtained in step S15 (step S16, output step). For example, the wire data generating unit 17 stores in the database 30 and/or transmits to the manufacturing system 40 the wire data obtained in step S15.

Note that the wire data generating unit 17 may normally correct the archwire and generate wire data without a determination on the necessity of archwire correction. In other words, step S14 can be omitted.

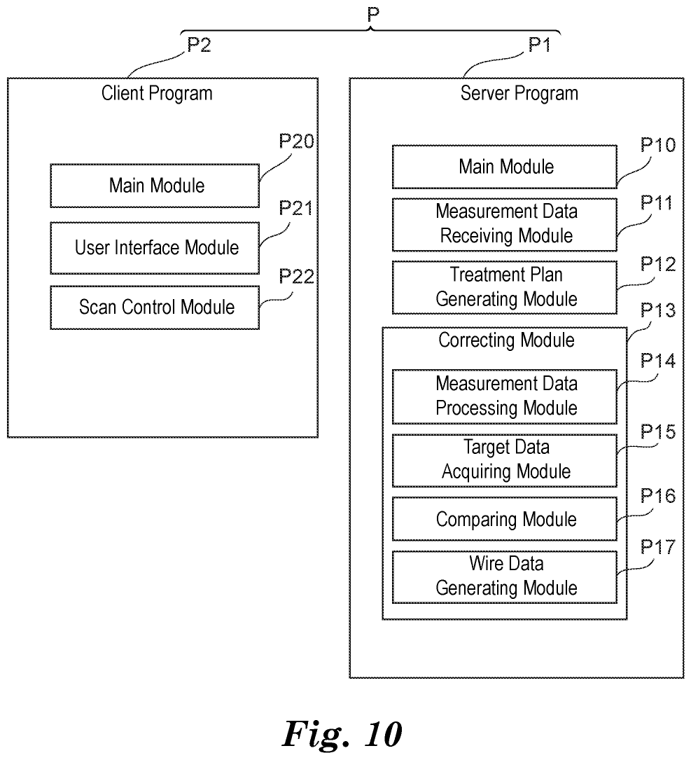

FIG. 10 illustrates a configuration of an orthodontics assisting program P. The orthodontics assisting program P for realizing the orthodontics assisting system 1 will be described below with reference to FIG. 10.

The orthodontics assisting program P includes a server program P1 configured to make a computer function as the server 10 and a client program P2 configured to make a computer function as the client terminal 20.

The server program P1 includes a main module P10, a measurement data receiving module P11, a treatment plan generating module P12, and a correcting module P13. The correcting module P13 includes a measurement data processing module P14, a target data acquiring module P15, a comparing module P16, and a wire data generating module P17. The main module P10 is a unit configured to manage processing in the server 10. Executing the measurement data receiving module P11, the treatment plan generating module P12, the correcting module P13, the measurement data processing module P14, the target data acquiring module P15, the comparing module P16, and the wire data generating module P17 realizes the measurement data receiving unit 11, the treatment plan generating unit 12, the correcting unit 13, the measurement data processing unit 14, the target data acquiring unit 15, the comparing unit 16, and the wire data generating unit 17.

The client program P2 includes a main module P20, a user interface module P21, and a scan control module P22. The main module P20 is a unit configured to manage processing in the client terminal 20. Executing the user interface module P21 and the scan control module P22 realizes the user interface 21 and the scan control 22.

The orthodontics assisting program P may be provided, for example, in the form of being recorded in a static manner on a tangible recording medium such as a CD-ROM, DVD-ROM, or semiconductor memory. Alternatively, the orthodontics assisting program P may be provided as a data signal superimposed onto a carrier wave through a communication network. The server program P1 and the client program P2 may be provided together or separately.

As described above, according to the orthodontics assisting system of the present embodiment, the difference between the target data showing the target dentition, i.e., the dentition desired for the patient, and the measurement data showing the actual dentition of the patient (dentition during treatment) is obtained and, based on the difference, a wire data showing the corrected shape of the archwire is generated. According to this series of processes, a suitable shape for the archwire can be achieved better than that known in the art. Accordingly, for example, the generated wire data can be sent to a machining device configured to bend the wire, and, using the wire data, an accurate archwire can be manufactured without manual work.

Additionally, the dentition can be scanned with the brackets attached. This allows the position and orientation of the brackets in the mouth to be accurately obtained and the wire to be accurately corrected.

According to the orthodontics assisting system of the embodiment, the archwire represented by the wire data can be divided into segments corresponding to the brackets, and in the generation step, the shape of the archwire can be corrected in each of the segments. By correcting each segment of the segmented archwire, the archwire can more accurately be given a desired shape.

According to the orthodontics assisting system of the embodiment, in the generation step, the shape of the archwire may be corrected by deforming the archwire in the direction opposed to the difference. Deforming the archwire in this manner raises the chances of deviation of the actual dentition from the target dentition being resolved early.

According to the orthodontics assisting system of the embodiment, in the generation step, the direction opposed to the difference may be determined based on at least one of: position, torque, angulation, and rotation of the archwire. By taking this elements into consideration, the archwire can more accurately be given a desired shape.

The comparing unit, for example, may further compare the target data and the measurement data in terms of the positional relationship between the dentition and the brackets. When the result of the positional relationship comparison indicates that the difference in the positional relationship between the target data and the measurement data is greater than a predetermined threshold value, the user may be prompted with a message recommending reinstallation of the brackets. Here, “reinstallation” refers to changing the position where the brackets are attached to the teeth. This message may include information for specifying the bracket/s for which reinstallation is recommended (for example, the shape or position of the bracket, or the type or number of the tooth installed with the bracket). The comparing unit may display the message on the client terminal, and the client terminal may display the message. For example, the client terminal may display the message as a three-dimensional graphic of the dentition and brackets. For example, the client terminal may recommend reinstallation to the user via a sound prompt. Threshold value may be a value that differs depending on the type of tooth which is the target for installation and/or the stage of treatment.

In other words, according to an orthodontics assisting system of the present modified example, in the comparison step, a message can be output recommending reinstallation of the brackets to the user when the difference is greater than a predetermined threshold value.

In the embodiments described above, examples in which the wire is corrected based on the position of the brackets were described. However, in another embodiment, the wire may be corrected in a similar manner based on the position of the buccal tubes.

In the embodiments described above, the orthodontics assisting system 1 is a client server system, however, the system configuration is not limited thereto. For example, a single computer may include the functions of both the server 10 and the client terminal 20, or may include the functions of the server 10, the client terminal 20, and the database 30.

The processes of the method of assisting orthodontics performed by at least one processor are not limited to that of the embodiments described above. For example, one or more of the steps (processes) described above may be omitted, or the steps may be performed in a different sequence. Additionally, any two or more steps of the steps described above may be merged, and one or more of the steps may be modified or deleted. Alternatively, another step in addition to those described above may be performed.

Various embodiments of the present invention have been described, however, these embodiments are merely examples and are not intended to limit the scope of the claims. These novel embodiments can be implemented in various other forms and various omissions, substitutions, and modifications can be made without departing from the gist of the invention. These embodiments and modifications thereof are included in the scope and gist of the invention and are included in the invention described in the claims and the equivalent scope thereof.

### REFERENCE NUMERALS

1 Orthodontics assisting system
10 Server
11 Measurement data receiving unit
12 Treatment plan generating unit
13 Correcting unit
14 Measurement data processing unit
15 Target data acquiring unit
16 Comparing unit
17 Wire data generating unit
20 Client terminal
21 User interface
22 Scan control
30 Database
40 Manufacturing system
50 Scanner
P Orthodontics assisting program
P1 Server program
P10 Main module

P11 Measurement data receiving module
P12 Treatment plan generating module
P13 Correcting module
P14 Measurement data processing module
P15 Target data acquiring module

P16 Comparing module
P17 Wire data generating module
P2 Client program
P20 Main module
P21 User interface module

P22 Scan control module

1. A computer-implemented method of assisting orthodontics, comprising:
a first acquisition step of acquiring target data showing a target dentition with a plurality of brackets installed;
a second acquisition step of acquiring measurement data obtained by scanning an actual dentition of a patient with the plurality of brackets installed;
a comparison step of obtaining a difference between the target data and the measurement data by comparing the target data and the measurement data; and
a generation step of correcting a shape of an archwire attached to the plurality of brackets based on the difference, and generating wire data showing a corrected shape.

2. The method of assisting orthodontics according to claim 1, wherein
in the first acquisition step, position and orientation of the plurality of brackets shown in the target data are acquired;
in the second acquisition step, position and orientation of at least the plurality of brackets installed on teeth are acquired from the measurement data; and
in the comparison step, the difference between the position and the orientation of the plurality of brackets shown in the target data and the position and the orientation of the plurality of brackets shown in the measurement data is obtained.

3. The method of assisting orthodontics according to claim 1, wherein
the archwire represented by the wire data is divided into a plurality of segments corresponding to the plurality of brackets; and
in the generation step, the shape of the archwire is corrected in each of the plurality of segments.

4. The method of assisting orthodontics according to claims 1, wherein
in the generation step, the shape of the archwire is corrected by deforming the archwire in a direction opposed to the difference.

5. The method of assisting orthodontics according to claim 4, wherein
in the generation step, the direction opposed to the difference is determined based on at least one of: position of the archwire, torque, angulation, and rotation.

6. The method of assisting orthodontics according to claims 1, wherein
in the comparison step, a message is output recommending reinstallation of the plurality of brackets to a user when the difference is greater than a predetermined threshold value.

7. An orthodontics assisting system, comprising:
a first acquiring unit configured to acquire target data showing a target dentition with a plurality of brackets installed;
a second acquiring unit configured to acquire measurement data obtained by scanning an actual dentition of a patient with the plurality of brackets installed;
a comparing unit configured to obtain a difference between the target data and the measurement data by comparing the target data and the measurement data; and
a generating unit configured to correct a shape of an archwire attached to the plurality of brackets based on the difference, and generate wire data showing a corrected shape.

8. The method of assisting orthodontics according to claim 2, wherein
the archwire represented by the wire data is divided into a plurality of segments corresponding to the plurality of brackets; and
in the generation step, the shape of the archwire is corrected in each of the plurality of segments.

9. The method of assisting orthodontics according to claim 8, wherein in the generation step, the shape of the archwire is corrected by deforming the archwire in a direction opposed to the difference.

10. The method of assisting orthodontics according to claim 9, wherein in the generation step, the direction opposed to the difference is determined based on at least one of: position of the archwire, torque, angulation, and rotation.

11. The method of assisting orthodontics according to claim 2, wherein in the comparison step, a message is output recommending reinstallation of the plurality of brackets to a user when the difference is greater than a predetermined threshold value.
